(19) United States
(12) Patent Application Publication
(10) Pub. No.: US 2007/0199351 A1
(43) Pub. Date: Aug. 30, 2007

(54) Apparatus and method for washing optical elements

(75) Inventors: Ching-Chou Chang, Tu-Cheng (TW); Chi-Chuang Ho, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,906

(22) Filed: Oct. 26, 2006

(30) Foreign Application Priority Data
Feb. 17, 2006 (CN) 200610033803.2

(51) Int. Cl. B08B 3/12

(52) U.S. Cl. 68/4

(57) ABSTRACT

An exemplary apparatus for washing one or more optical elements includes an upper portion (10) and a lower portion (20). The upper portion includes a plurality of upper washing holes (14) defined therein. The lower portion cooperates with the upper portion to form a washing chamber (30). The lower portion includes a plurality of lower washing holes (24) defined therein. The washing chamber is configured for holding the optical elements.

1. Field of the Invention

The present invention relates to washing apparatuses and, in particular, to an apparatus for washing optical elements such as lenses.

2. Description of Related Art

Nowadays, optical elements such as lenses are in widespread use in devices such as digital cameras and digital video recorders. There is more and more demand for higher quality and serviceability of these optical elements. In general, a film such as an anti-reflective film or an infrared cut film coated on each optical element, especially if the optical element is a lens. To improve imaging quality, it is an important first step to wash the optical element before coating a film thereon. How to wash optical elements effectively before coating is an important technology.

Usually, optical elements are washed by a concussion of ultrasonic waves in a vessel filled with liquid. For example, referring to FIG. 7, an optical element washing apparatus is shown. The optical element washing apparatus includes a washing box 81, a vessel 82, and an engine 83. The washing box 81 is a sealed cylinder including a cover 84. The washing box 81 is filled with a liquid 85, and a lens 86 is disposed in the liquid 85. The vessel 82 is a sealed vessel, including a top portion and a bottom portion. The top portion is filled with water 87, and the washing box 81 is floated in the water 87. The engine 83 is mounted on the bottom portion, and the engine 83 can produce ultrasonic waves. The ultrasonic waves can be transmitted to the washing box 81 via the water 87. Thus, the lens 86 can be washed in the liquid 85. However, the optical element washing apparatus can only wash lenses one by one. Therefore, the efficiency of the optical element washing apparatus is low, and this related washing apparatus is not practical for washing large numbers of optical elements within a short period of time.

Therefore, a new apparatus for washing optical elements is desired in order to overcome the above-described shortcomings.

### SUMMARY OF THE INVENTION

In one embodiment, an apparatus for washing one or more optical elements includes an upper portion and a lower portion. The upper portion includes a plurality of upper holes defined therein. The lower portion cooperates with the upper portion to form a washing chamber. The lower portion includes a plurality of lower holes defined therein. The washing chamber is configured for holding the optical elements.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is a schematic, isometric view of an apparatus for washing optical elements in accordance with a preferred embodiment of the present invention, the apparatus including an upper portion and a lower portion.

FIG. 2 is an inverted view of the upper portion of the apparatus of FIG. 1.

FIG. 3 is a view of the lower portion of the apparatus of FIG. 1, shown in isolation.

FIG. 4 is a cross-sectional view taken along line IV-IV of FIG. 1.

FIG. 5 is a schematic, isometric view of an outer housing for holding the apparatus of FIG. 1.

FIG. 6 is similar to FIG. 4, but showing the apparatus held in the outer housing, and showing two water pipes connected to the outer housing.

FIG. 7 is a schematic, cross-sectional view of a conventional optical element washing apparatus, together with a lens being washed in the washing apparatus.

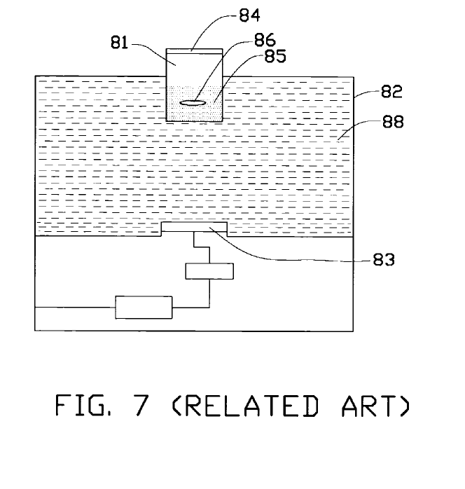

### DETAILED DESCRIPTION OF THE INVENTION

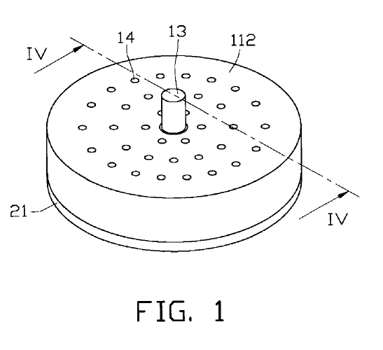

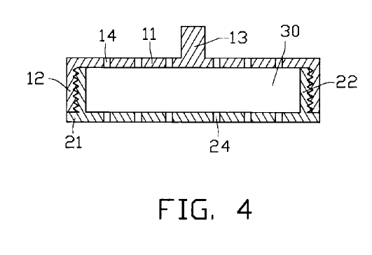

Referring to FIGS. 1-6, in a preferred embodiment, an apparatus for washing optical elements includes an upper portion 10, a lower portion 20, and an outer housing 40. The upper portion 10 and the lower portion 20 are configured for holding optical elements to be washed. In this embodiment, the optical elements can for example be infrared cut filters, anti-reflective filters, or ultraviolet cut filters.

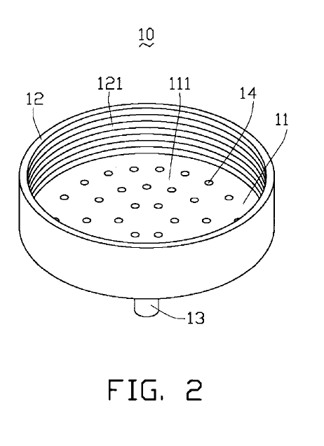

Referring to FIGS. 1-2, the upper portion 10 includes a top cover 11, a first side housing 12, and a handle 13. The top cover 11 has an outer surface 112 and an inner surface 111. The handle 13 is formed on the outer surface 112, and the first side housing 12 is formed on the inner surface 111. A predetermined amount of upper washing holes 14 are evenly defined in the top cover 11. The upper washing holes 14 penetrate from the inner surface 111 to the outer surface 112 of the top cover 11; that is, the upper washing holes 14 are through holes. The top cover 11 has a disk-like shape, and the first side housing 12 has a cylindrical shape extending down from the top cover 11. A first screw thread 121 is formed on an inner surface of the first side housing 12. In this embodiment, the upper portion 10 is made of transparent material.

Referring to FIGS. 1 and 3-4, the lower portion 20 includes a bottom board 21 and a second side housing 22. The bottom board 21 has a disk-like shape, and the second side housing 22 has a cylindrical shape extending up from the bottom board 21. A second screw thread 221 is formed on an outer surface of the second side housing 22. The second screw thread 221 cooperates with the first screw thread 121 to secure the upper portion 10 on the lower portion 20. Thus, the first side housing 12 and the second side housing 22 form a holding chamber 30 to hold the optical elements to be washed. A predetermined number of lower washing holes 24 are evenly defined in the bottom board 21. The lower washing holes 24 are through holes. In this embodiment, the lower portion 20 is made of a transparent material.

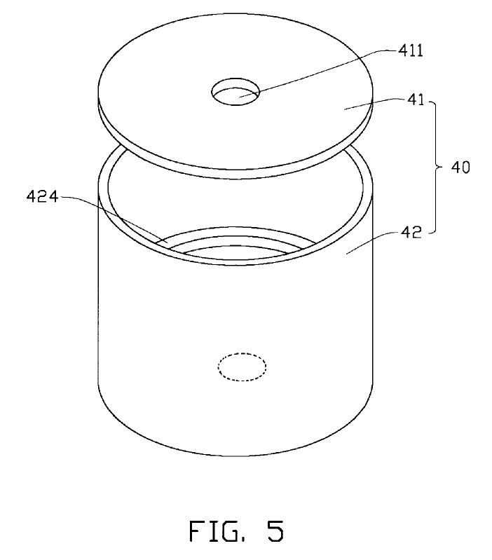

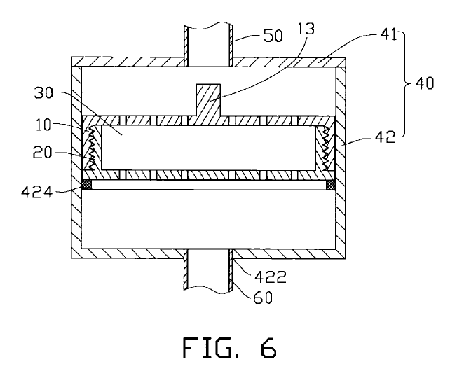

Referring to FIGS. 5-6, the outer housing 40 includes a cylindrical barrel 42 and a cover 41. The cover 41 can be removably attached on the cylindrical barrel 42. The cover 41 has a disk-like shape, and a first through hole 411 is defined therein. The first through hole 411 can have a first water pipe 50 connected therein. A second through hole 422 is defined in a transverse bottom wall (not labeled) of the cylindrical barrel 42. The second through hole 422 can have a second water pipe 60 connected therein. An annular step 424 is formed on an inner surface of the cylindrical barrel 42. A diameter of the cylindrical barrel 42 is slightly larger than a common outer diameter of the upper portion 10 and the lower portion 20. In this embodiment, the outer housing 40 is made of a transparent material.

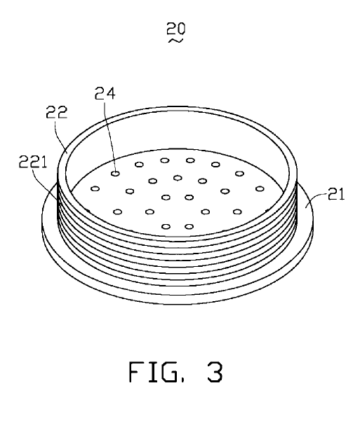

Referring to FIGS. 3-5, in use, firstly, a predetermined number of optical elements are disposed in the lower portion 20. Secondly, the handle 13 is rotated, whereby the upper portion 10 is locked on the lower portion 20 by cooperation between the first screw thread 121 and the second screw thread 221. Thirdly, the combined upper portion 10 and lower portion 20 is disposed in the cylindrical barrel 42 and supported on the step 424. Fourthly, the cover 41 is attached onto the cylindrical barrel 42. Fifthly, a flow of water is introduced into the outer housing 40 through the first water pipe 50. Sixthly, the water flows into the washing chamber 30 through the upper washing holes 14, thereby washing the optical elements in the washing chamber 30. Seventhly, waste water flows out of the washing chamber 30 through the lower washing holes 24. Finally, the waste water is discharged out of the outer housing 40 through the second water pipe 60.

After washing the optical elements, the cover 41 is removed, and the upper portion 10 is unlocked from the lower portion 20 by rotating the handle 13. Then the washed optical elements can be taken out of the washing chamber 30.

The apparatus for washing optical elements can wash more than one optical element at a time. Furthermore, the waste water produced in washing the optical elements can be timely discharged out of the apparatus so that the optical elements are not fouled by the waste water.

It is believed that the present embodiments and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

What is claimed is:

1. An apparatus for washing one or more optical elements, comprising:
an upper portion including a plurality of upper washing holes defined therein; and
a lower portion cooperating with the upper portion to form a washing chamber, the lower portion including a plurality of lower washing holes defined therein;
wherein the washing chamber is configured for holding the optical elements.

2. The apparatus as claimed in claim 1, wherein the upper portion includes a top cover, a first side housing, and a handle.

3. The apparatus as claimed in claim 2, wherein the top cover has an outer surface and an inner surface, the handle is formed on the outer surface, and the first side housing extends from the inner surface.

4. The apparatus as claimed in claim 3, wherein the first side housing is cylindrical in shape, and a first screw thread is formed on the first side housing.

5. The apparatus as claimed in claim 4, wherein the lower portion includes a bottom board and a second side housing extending from the bottom board.

6. The apparatus as claimed in claim 5, wherein the second side housing is cylindrical in shape, a second screw thread is formed on the second side housing, and the second screw thread cooperates with the first screw thread of the first side housing to form the washing chamber.

7. The apparatus as claimed in claim 5, wherein the upper washing holes are defined in the top cover of the upper portion, and the lower washing holes are defined in the bottom board of the lower portion.

8. The apparatus as claimed in claim 5, wherein the upper portion and the lower portion are each made of transparent material.

9. The apparatus as claimed in claim 1, further comprising an outer housing for holding the upper portion and the lower portion therein.

10. The apparatus as claimed in claim 9, wherein the outer housing includes a cylindrical barrel and a cover, and the cover is removably attached on the barrel.

11. The apparatus as claimed in claim 10, wherein the cover defines a first through hole, and a bottom of the barrel defines a second through hole.

12. The apparatus as claimed in claim 10, wherein the outer housing is made of transparent material.
